(19) United States
(12) Patent Application Publication
(10) Pub. No.: US 2019/0031396 A1
(43) Pub. Date: Jan. 31, 2019

(54) Plastic Bottle Storage Apparatus For A Garage Door

(71) Applicant: Tommy L. Patton, Oak Glen, CA (US)

(72) Inventor: Tommy L. Patton, Oak Glen, CA (US)

(21) Appl. No.: 15/659,514

(22) Filed: Jul. 25, 2017

(51) Int. Cl. B65D 21/02; B65D 71/72; E06B 3/70; B65F 1/08; B65F 1/00

(52) U.S. Cl. CPC B65D 21/0208; B65D 71/72; E06B 3/7001; B29L 2031/7158; B65F 1/0033; B65F 2250/116; B65F 2001/0086; B65F 1/085

(57) ABSTRACT

A plastic bottle storage apparatus for a garage door (PBSA) that is used in combination with an empty plastic bottle panel or strip which maintains empty plastic bottles prior to recycling. The PBSA has an upper section with an upper horizontal member, and a lower section with a lower horizontal member. An empty plastic bottle panel or strip with empty plastic bottles attached is secured to a hook clip or peg on the upper opening on the panel's or strip's upper end, and to a hook, clip or peg on an upper end of the opening on the panel's or strip's lower end. Once panels or strips with empty bottles are secured, the panels or strips with bottles can be maintained on the garage door indefinitely. The PBSA is able to compensates for the variations in length that occur as a sectional garage door opens and closes.

### TECHNICAL FIELD

The invention generally pertains to storage device, and more particularly to an apparatus that is attached to an inner surface of a garage door for storing empty plastic bottles.

### BACKGROUND ART

Throughout the world, and especially in developed countries, one of the most important issues is the use and disposal of various items. Due to the convenience and large use of many items there is not enough room in landfills to accommodate all of the refuse. That is why recycling is encouraged, or mandated, for items that can be recycled.

One of the most widely encountered of the recyclable items is plastic bottles, and in particular, plastic water bottles. In the United States alone there are billions of plastic water bottles used each year, with only a small percent being recycled even though there is typically a cash redemption value for each bottle. The reason for this is because, for many people, recycling is an inconvenience. A large part of this results from the need to store empty plastic bottles before transporting them to a recycling facility.

Storing empty plastic water bottles is exacerbated when other plastic bottles, such as soft drink or sports drink is added. Even when ‘empty” these bottles can create a messy, sticky eyesore, that can attract insects such as ants. As a result, most people who do save empty plastic bottles keep them in a garage. All this does though is create a problem in the garage. There is also the chore of collecting all the empty bottles in the garage and arranging them for transport to a recycling facility. Invariably these problems have caused many people to simply give up on recycling.

What is needed is a convenient, clean and unobtrusive way of collecting and storing empty plastic bottles in a garage. A storage apparatus that could be placed at an existing location where empty bottles could be maintained for an extended period of time, and that would not interfere with the normal use or functions of the garage, would be optimal. A storage apparatus that is placed on a garage door would be easy to install, would require little or no maintenance, and could be used with various sized powered or manual garage doors.

A search of the prior art did not disclose nay literature or patents that read directly on the claims of the instant invention. However, the following U.S. patents are considered related:

| PATENT NO. | INVENTOR | ISSUED |
|---|---|---|
| 6,725,608 | Krause | Apr. 27, 2004 |
| 7,958,925 | Murray | Jun. 14, 2011 |
| 8,468,745 | Krause | Jun. 25, 2013 |

The U.S. Pat. No. 6,725,608 patent discloses a storage assembly consisting of a storage space below a garage ceiling with rafters and a ceiling panel and above an opened overhead garage door. The ceiling panel has tie receiving apertures, a plurality of ceiling catching beams, a plurality of metal ties and a plurality of fasteners securing the ties to the ceiling catching beams. Fasteners are attached to the lower ends of the ties, and a shelf panel overlies the shelf catching beams. The lower end of the ties overly the opened overhead garage door.

The U.S. Pat. No.7,958,925 patent discloses a storage device for use with a garage door having multiple panels that are connected together by hinges and fasteners. The fasteners are disposed in vertical alignment at a top part and bottom part of at least one of the panels, and include a storage container having a peripheral support structure which is normally maintained adjacent the panel and includes a plurality of eyelets which receive one of the fasteners therethrough.

The U.S. Pat. No. 8,468,745 patent discloses a lifting and storage mechanism for storing a component in a garage using the energy of a powered garage door opening and closing system. The lifting and storage mechanism includes a pulley system for raising and lowering the components and a latching mechanism with a spring latch for secures the components. In order to lower the components from a storage position, an operator initiates manual release of the spring latch or activation of an electromechanical release combined with activation of the motor of the powered garage door.

For background purposes and indicative of the art to which the invention relates, reference may be made to the following remaining patents found in the patent search.

| PATENT NO. | INVENTOR | ISSUED |
|---|---|---|
| 4,378,043 | Sorenson | Mar. 29, 1983 |
| 6,276,539 | Richbourg | Aug. 21, 2001 |
| 7,000,783 | Webb | Feb. 21, 2006 |
| 7,325,785 | Krengel, et al | Feb. 5, 2008 |
| 2003/0213763 | Morin, et al | Nov. 20, 2003 |
| 2006/0038468 | Morgan | Feb. 23, 2006 |

### DISCLOSURE OF THE INVENTION

A plastic bottle storage apparatus for a garage door (PBSA) that is used in combination with multiple empty plastic bottle panels or strips which are used to maintain empty plastic bottles, with or without caps, prior to recycling.

The preferred embodiment of the PBSA has an upper section with a horizontal member including securing means and a lower section with a horizontal member including securing means that is placed parallel to, at a distance from, the upper section horizontal member. In an alternate configuration, located on the upper section horizontal member are securing means and on the lower section horizontal member are corresponding securing means. The upper and lower securing means can comprise a hook, a peg, a hook and loop fasteners, a strap an adhesive, a bolt and nut, a latch, a twist lock, a rod, or a pin. A resilient band can be attached at a lower end to the lower section horizontal member. The band's upper end has securing means such as a hook or a clip. The two horizontal members can be made of various materials including plastic, metal or wood, and they can be removably or permanently secured to an inner surface of a garage door, which is preferably a sectional type garage door.

The preferred method of securing the horizontal member utilizes a design incorporating a retractable pin that extends from each end of the members. The pin enters into an opening on an existing hinge bracket on the garage door, thereby securing the member onto the door. Alternately, a retractable pin can only be on one end, with a stationary pin on the opposing end.

Multiple empty bottle panels or strips, with empty plastic bottles secured thereto, are attached to the PBSA. An upper end of each panel or strip has an opening that interfaces with the securing means on the upper section horizontal member. A lower end of each panel or strip also has an opening that interfaces with the securing means on the lower section horizontal member. Once a panel or strip with empty plastic bottles is secured, the panel or strip with bottles can be maintained on the PBSA for an indefinite period of time. The PBSA, either with or without the resilient band is able to compensate for the variations in length that occur as the sectional garage door open and closes.

In view of the above disclosure, the primary object of the invention is to provide a plastic bottle storage apparatus for a garage door that allows multiple empty plastic bottle panels or strips with empty bottles attached thereto, to be secured and maintained on an inner surface of a sectional garage door while permitting the garage door to open or close as per normal operation.

In addition to the primary object, it is also an object of the invention to provide a plastic bottle storage apparatus for a garage door that:
is easy to use,
is easy to install,
can be sold as a component of a new garage door or as an aftermarket product,
can be used with powered or manual garage doors,
can maintain a large number of empty plastic bottles,
keeps a garage clean and free of randomly placed empty plastic bottles,
encourages recycling
can be used by adults and children,
is durable and long-lasting,
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is an orthographic front view of a plastic bottle storage apparatus for a garage door (PBSA) attached to an inner surface of a sectional garage door and with seven empty plastic bottle recycling strips, each maintaining twenty-five empty plastic bottles.

FIG. 2 is an orthographic front view of the PBSA attached to an inner surface of a sectional garage door, without recycling strips and empty plastic bottles.

FIG. 3 is an orthographic detach view of an upper corner of the PBSA attached to an inner surface of a sectional garage door, with recycling strips and bottles.

FIG. 4 is an orthographic front view of multiple PBSAs attached to an entire inner surface of a sectional garage door, with recycling strips and bottles attached utilizing a resilient band on a lower section horizontal member.

FIG. 5 is an orthographic corner detail view of a two strips attached to the upper section horizontal member by hooks that are slideably attached onto the member.

FIG. 6 is an orthographic corner detail view of the PBSA with strip attachment hooks on the upper section horizontal member strip attachment pegs on the lower section horizontal member, and hanging devices extending from a lower edge of the lower section horizontal member.

FIG. 7 is an orthographic front view of the PBSA attached to an inner surface of a sectional garage door and with six empty bottle recycling strips, each maintaining twenty-five empty plastic bottles.

FIG. 8 is an orthographic front view of the PBSA preferred securing design which utilizes an extending pin from each end of the upper and lower horizontal members, with the pin entering into an opening on a hinge bracket vertically located on an inner surface of a sectional garage door.

FIG. 9 is an orthographic corner detail of two strips attached to the upper horizontal member by two protrusions supporting each strip.

FIG. 10 is an orthographic front view of multiple PBSA attached to an entire inner surface of a sectional garage door, with horizontal members secured utilizing the preferred pin-in-opening design, and with recycling strips and bottles attached thereto.

FIG. 11 is an elevational cut-away view showing a telescoping section of the horizontal member, and a pin and spring located within a horizontal member, adjacent an end of the member, and with the pin extending outward from the horizontal member's end.

FIG. 12 is an elevational cut-away view showing a horizontal member with a spring activated retractable pin on one end and a stationary pin on the opposing end.

### BEST MODE FOR CARRYING OUT THE INVENTION

The best mode for carrying out the invention is presented in terms that disclose a preferred embodiment of a plastic bottle storage apparatus for a garage door (PBSA). The act of recycling, and in particular recycling plastic beverage bottles, has become one of the most important issues in the modern world. The convenience of making, selling and using plastic bottles for beverages, especially water, coupled with the number of people using plastic bottles, has led to a major environmental problem. Recycling plastic bottles would have a positive impact on the problem, and as a result, in many states and cities in the United States, incentives including cash redemption value, or even mandates have attempted to influence or force people to recycle plastic bottles. The problems that cause people not to recycle include the difficult in maintaining empty plastic bottles prior to recycling. There is the obvious requirement for space to store empty plastic bottles, along with the effort to arrange and transport empty bottles to a recycling facility, and lastly the often sticky, messy handling of certain bottles.

The instant PBSA provides a solution to the problems by facilitating the effective and convenient storage of many empty plastic bottles within a residential (or commercial) garage. The PBSA offers quick and easy access to stored empty bottles, and does away with much of the associated mess.

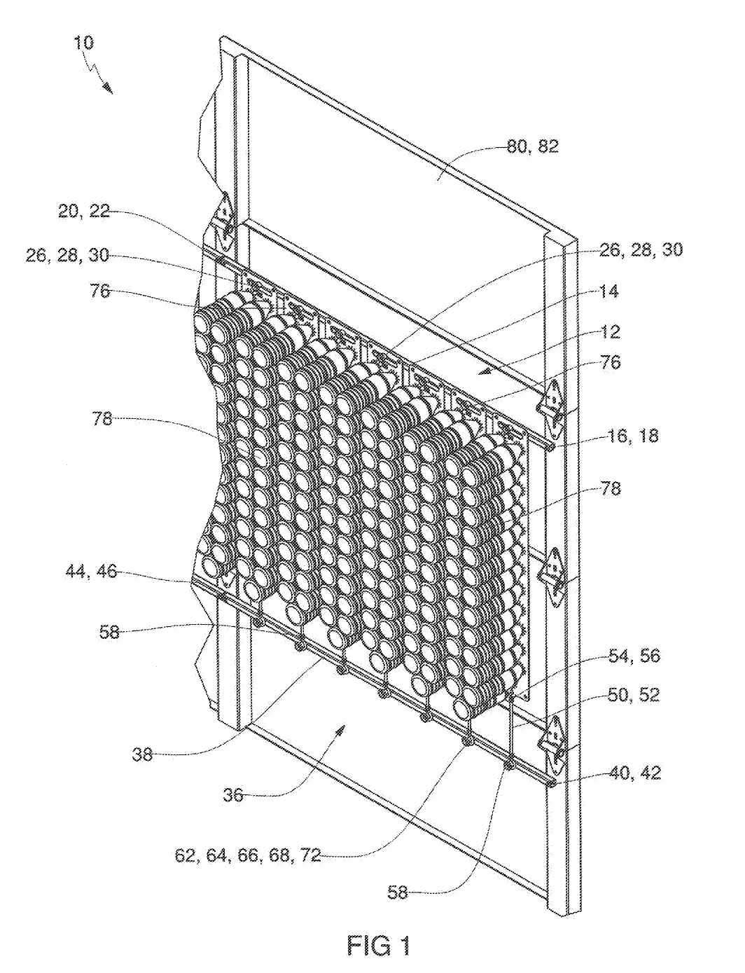

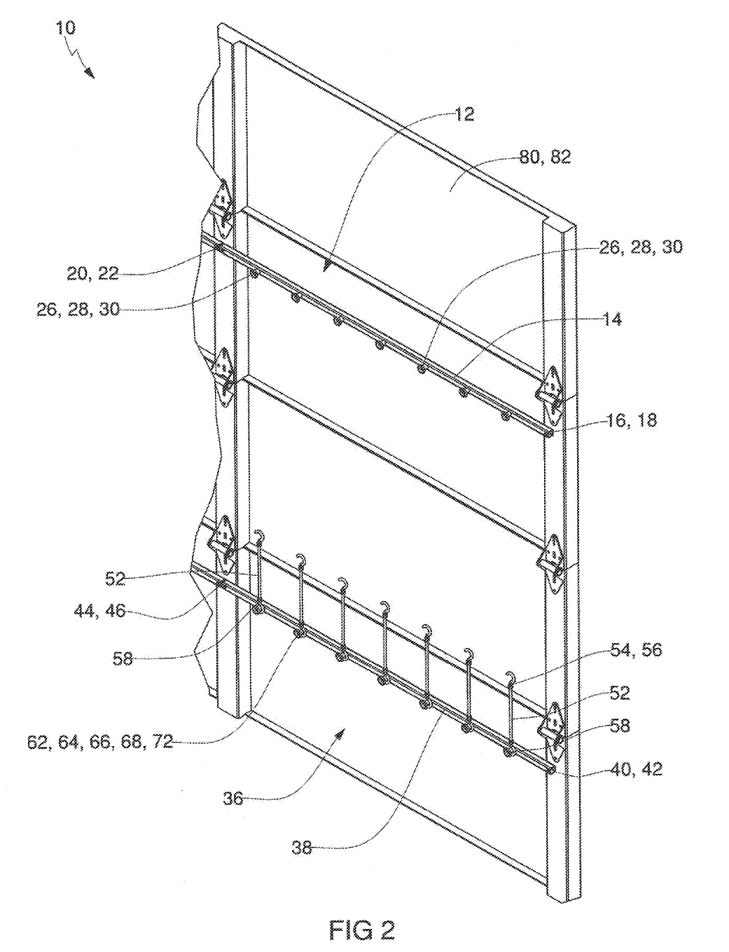

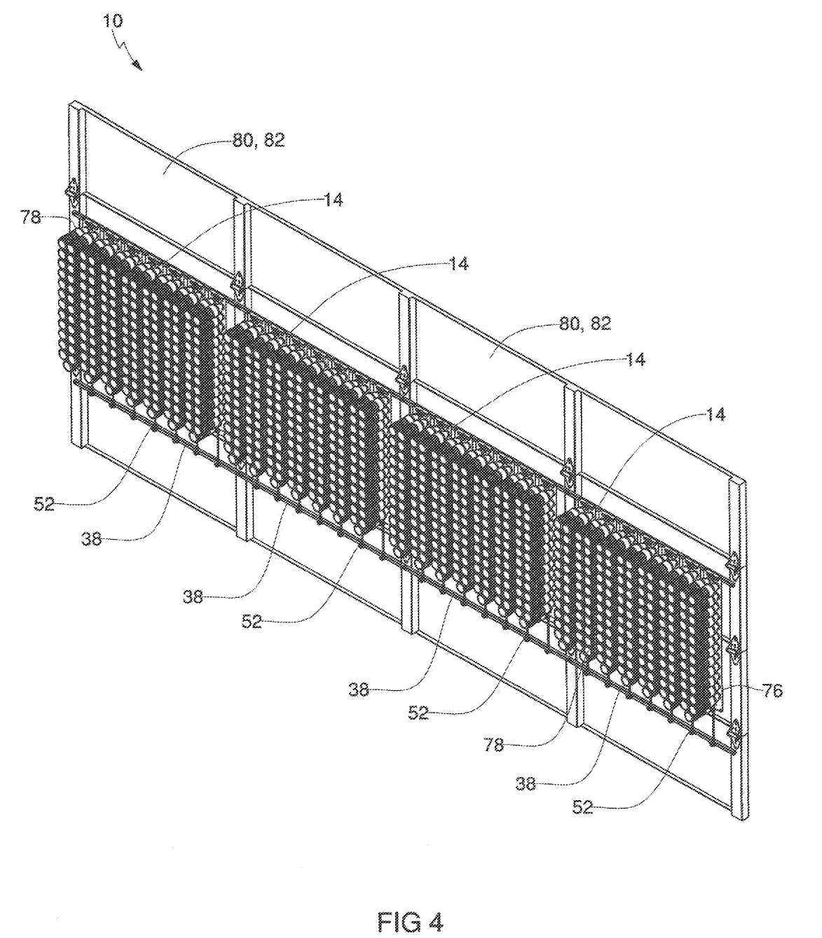

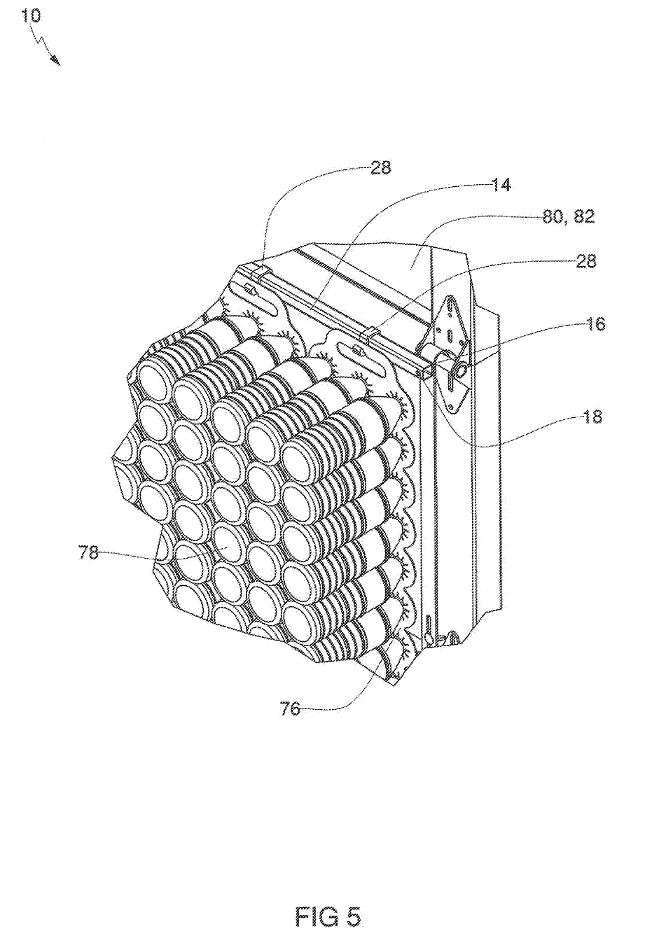

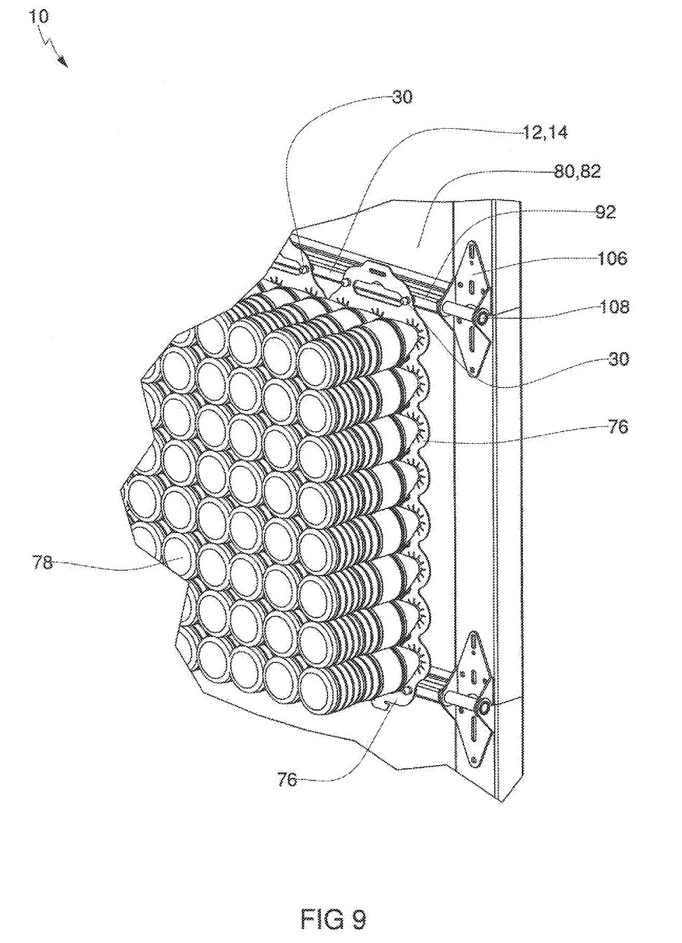

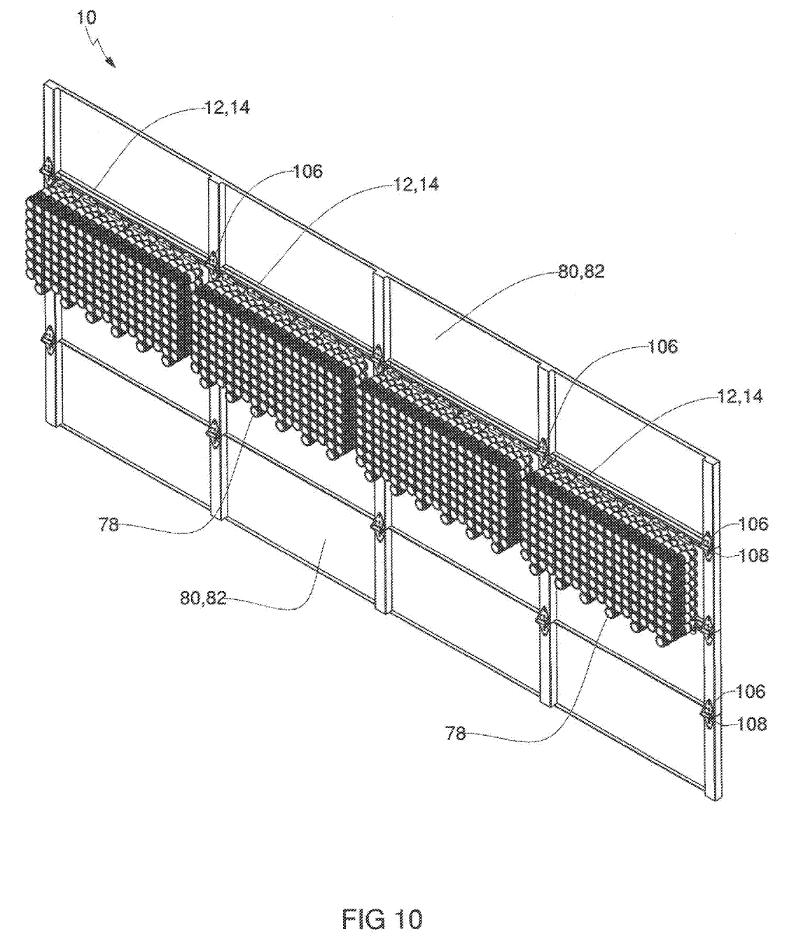

The PBSA 10, as shown in FIGS. 1-12, is used in combination with an empty plastic bottle storage panel or strip 76. The panel or strip 76 is a component of an empty plastic bottle recycling system, which offers a complete solution to the facilitation of recycling plastic bottles. The panel or strip 76, which is currently patent pending in a previously filed utility patent application by the same inventor, allows multiple empty plastic bottles to be inserted into openings on the panel or strip and maintained on the panel or strip.

The PBSA 10 provides a storage solution or a single panel or strip, or multiple panels or strips, on an inner surface 82 of a garage door 80. While the PBSA can be used with any type of garage door, or in fact on any surface, the PBSA is especially designed for use on a sectional garage door that consists of multiple sections which are hingedly connected and raise or lower vertically on a track. Also, the PBSA can be used with both manual (non-powered) or powered sectional garage doors.

The PBSA is comprised of two major elements: an upper section 12 and a lower section 36. The upper section 12, as shown in FIGS. 1-4, includes a horizontal member 14 that is made of plastic, metal or wood, with a right end 16 having securing means 18, and a left end 20 having securing means 22. The upper section horizontal member 14 is secured on each end to an inner surface 82 of a sectional garage door 80 by the respective securing means 18,22 which for example are comprised of at least one screw, at least one bolt and nut or an adhesive the horizontal member 14 is preferably removably attached but, if desired or required, can be permanently attached by the above securing means or others such as welding when the member 14 is made of metal.

Located on the upper section horizontal member 14 is an upper attachment means 26, as shown in FIGS. 1-4. The means 26 are comprised of at least one, and preferably multiple, hooks 28, pegs 30 or similar items that are longitudinally placed along the length of the member 14 and extend outward.

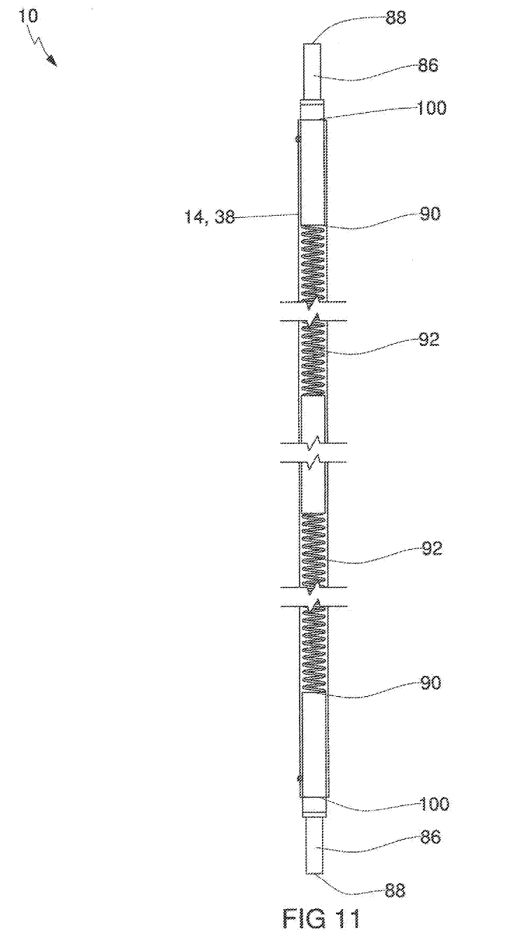

The lower section 36 also has a horizontal member 38 including a right end 40 with securing means 42, and a left end 44 with securing means 46. The lower section horizontal member 38 can be made of plastic, metal or wood, and is similarly secured to an inner surface 82 of a sectional garage door 80 as the upper section horizontal member 14. As shown in FIGS. 1, 2, and 4, the lower section horizontal member 36 is particularly placed at a location parallel to and below the upper section horizontal member 14. Also, if desired required, the upper and/or lower horizontal member 14,38 can be manufactured with telescoping capability 100, as shown in FIG. 11, which allows the length of each member to be selectively chosen by the insertion or retraction of sections of each member. To maintain a selected length of the horizontal member with the telescoping capability, a set screw 102, as shown in FIG. 11, can be utilized.

Attached to the lower section horizontal member 36 is a lower attachment means 50, which is comprised of at least one, and preferably multiple, resilient bands 52 which are located to vertically correspond to the hooks 28 or pegs 30 on the upper section horizontal member 14. The resilient band 52 can be made of any stretchable material such as elastic or rubber, and is preferably comprised of a BUNGEE CORD™ type.

As shown in FIGS. 1, 3 and 4, the resilient band 52 has an upper end 54 with a hook 56 or similar item, and a lower end 58 that is secured by band securing means 62 comprising a hook 64, eyelet and peg 66, clip and peg 68, or a screw 76, to the lower section horizontal member 36. Once secured, the4 resilient band 52 can be positionally manipulated about the lower section horizontal member 56.

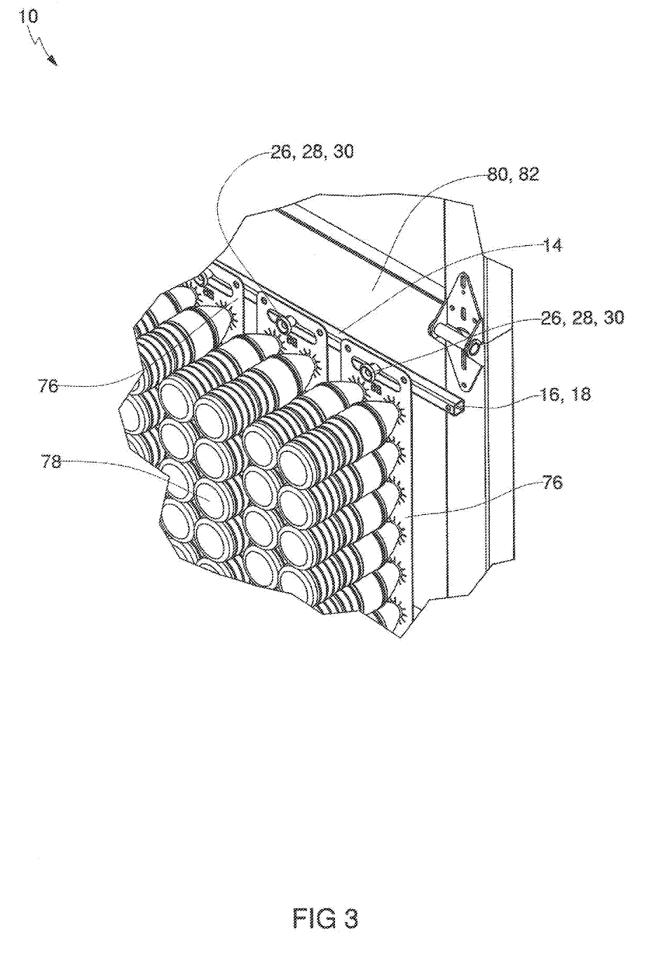

To use the PBSA 10, at least one panel or strip 76 is secured to the PBSA 10, as shown in FIGS. 1, 2 and 4. Each panel or strip 76 has an upper end with an opening that is attached onto the upper attachment means 26, as best shown in FIG. 3. A lower end of each panel or strip 76 also has an opening that is attached to the upper end 54 of the resilient band 52, as shown in FIGS. 1, 2, and 4. Once the upper end and the lower end of the panel or strip 76 are attached, the panel or strip 76 with empty plastic bottles thereon, can be maintained on the inner surface 82 of the sectional garage door 80 for an indefinite period of time. The resilient band 52 extends and contracts to compensate for the variations in length that occur when the garage door 80 opens and closes.

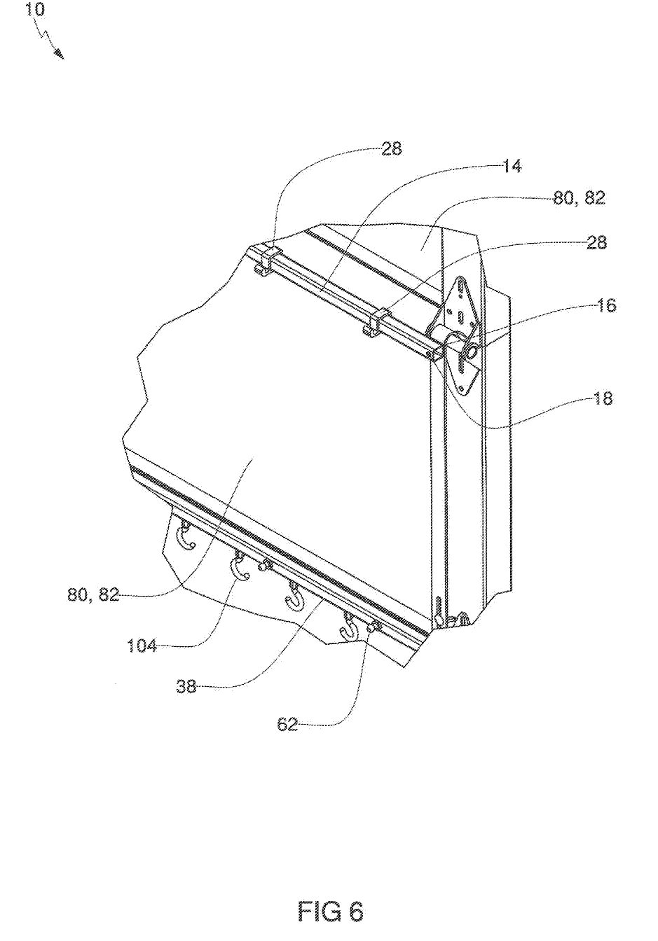

To add to the functionality of the PBSA 10, a vertically adjustable bracket 74 can be implemented. The bracket 74 is preferably attached to exiting garage door hardware and allows the PBSA 10 to be vertically raised or lowered to a desired or required height on the inner surface 82 of the sectional garage door 80. Also, located on a lower edge of the lower section horizontal member 38 can be at least one hanging device 104, as shown in FIG. 6. The hanging device 104 allows various items to be maintained on, and hung from, the lower section horizontal member 38, thereby increasing the functionality of the PBSA 10. The hanging device 104 can be comprised of various devices, including a hook, a peg, a clip, a stud, a knob, a protrusion, a chain, a cable, a rope, clamp, hook and loop fastener, strap, an adhesive, a bolt and nut, a resilient band, a latch, a twist lock, a rod, or a pin.

In an alternate configuration, which is the preferred design, the PBSA 10 is comprised of:

a) an upper section 12 including a horizontal member 14 with a right end 16 and a left end 18. The horizontal member 14 is secured to an inner surface 82 of a sectional garage door 80 by securing means 84 on the right end 16, and securing means 84 on the left end 20,

b) multiple upper attachment means 26 that are longitudinally located along the length of the upper section horizontal member 14,

c) a lower section 36 including a horizontal member 38 with a right end 40 and a left end 42. The horizontal member is secured below and parallel to the upper section horizontal member 38 on an inner surface 82 of the sectional garage door 80 by securing means 84, on the right end and securing means 84 the left end, and

d) multiple lower attachment means 50 that are located to directionally correspond to the upper attachment means.

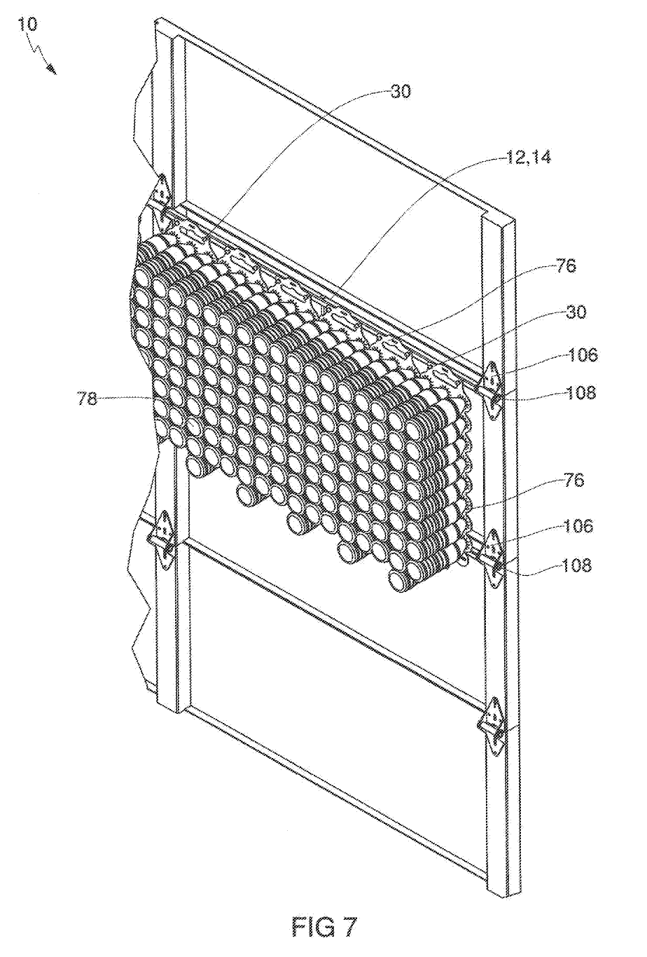

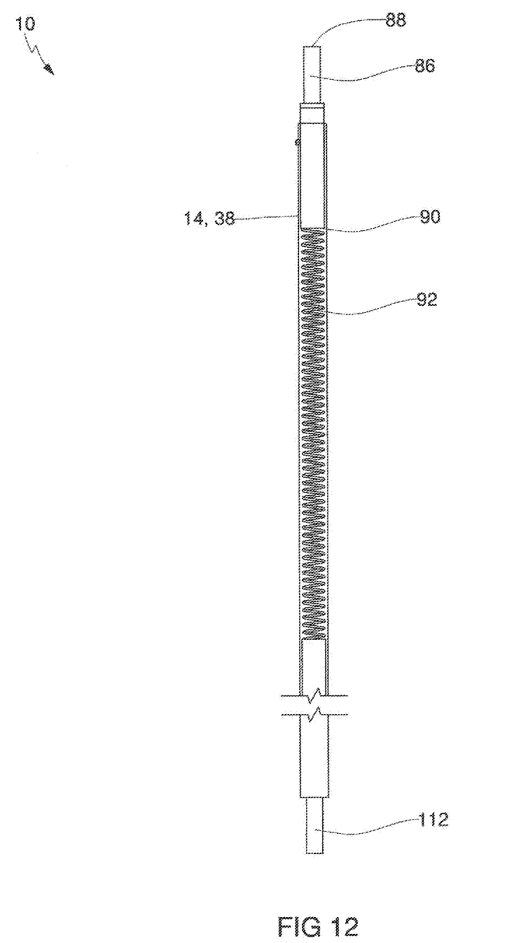

In the preferred design, the securing means 84 on the right and left ends 16,20 of the upper section horizontal member 14, and the right and left ends 40,44 of the lower section horizontal member 38 are comprised of a pin 86 with an outer end 88 and an inner end 90. As shown in FIG. 11, the retractable pin 86 extends outward from each end of both horizontal members 14,38. Within each member, adjacent each end, the pin's inner end 90 interfaces with a spring 92 that allows the pin 86 to be forcefully retracted into the horizontal member, or to releaseably extend outward from each end of the member. Located on an inner surface of a sectional garage door 84 as existing hardware are multiple hinge brackets 106 with each having openings 108 on an inner side edge. An end of one horizontal member, with the pin 86 retracted within the member, is placed in alignment with the opening 108 on a bracket 106. Once in alignment, the pin 86 is releaseably extended outward from the horizontal member into the opening. This pin-into-opening action is performed on both ends of the upper and lower horizontal members 14,38. When the pins 86 extend into the openings on both ends of each horizontal member, the member is secured onto the inner surface 82 of the garage door 84, as shown in FIGS. 7-10. In an alternate design, as shown in FIG. 12, a retractable pin 98 is only on one end of the horizontal member 14, and a stationary pin 112 is on the opposing end.

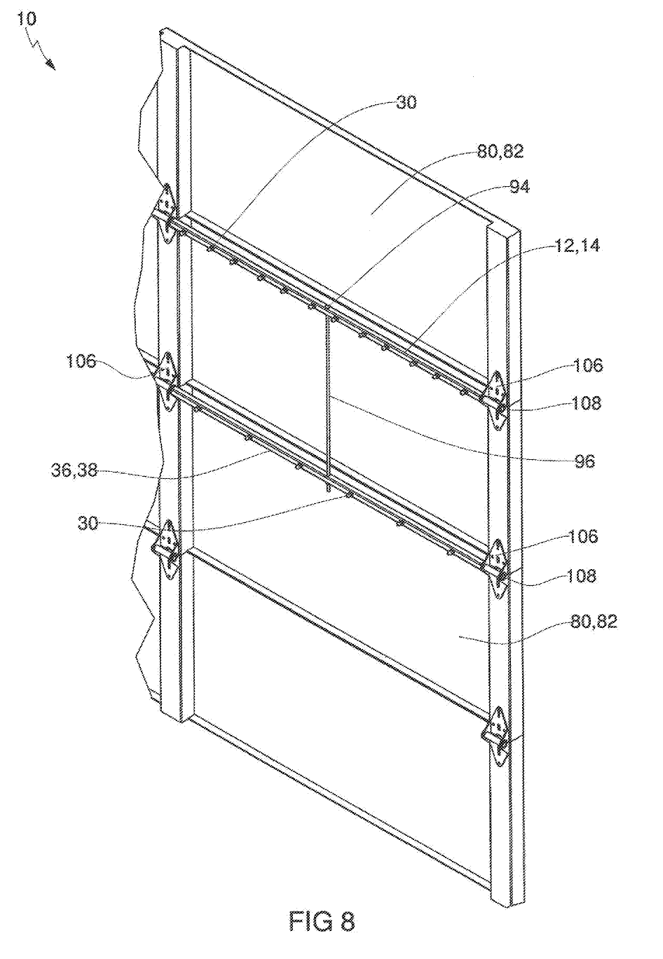

Additionally, both horizontal members 14,38 can have at least one opening 94 into which is inserted a vertical locking rod 96, as shown in FIG. 8. The rod 96 maintains the horizontal directional integrity and anti-rotation of the members 14,38, and prevents twisting movement from occurring.

The upper end of the panel or strip is secured to the upper attachment means by interfacing the opening on the upper end of the panel or strip with the upper attachment means, and the lower end of the panel or strip is secured to the lower attachment means by interfacing the opening on the lower end of the panel or strip with the lower attachment means 50. Once the panel or strip with empty bottles thereon is secured, the panel or strip with empty bottles, is maintained on the inner surface 82 of the garage door 80. The PBSA 10 is able to compensate for the variation in length that occurs when the sectional garage door opens and closes.

While the invention has been described in detail and pictorially shown in the accompanying drawings it is not to be limited to such details, since many changes and modifications may be made to the invention without departing from the spirit and the scope thereof. Hence, it is described to cover any and all modifications and forms which may come within the language and scope of the claims.

1. A plastic bottle storage apparatus for a garage door (PBSA) that is used in combination with an empty plastic bottle panel or strip which maintains empty plastic bottles prior to recycling, wherein said PBSA is comprised of at least one upper attachment means that is secured to an inner surface of a garage door and a corresponding lower attachment means including a resilient band that is secured to an inner surface of a garage door, wherein an upper end of the empty plastic bottle panel or strip is secured to said upper attachment means, and a lower end of the panel or strip is secured to an upper end of said resilient band, with a lower end of said band attached to said lower attachment means, wherein when the upper end and lower end of the panel or strip are secured, the panel or strip is maintained on the garage door.

2. The plastic bottle storage apparatus for a garage door as specified in claim 1 wherein said upper attachment means sand said lower attachment means are made of a material selected from the group consisting of plastic, metal, wood or a composite.

3. The plastic bottle storage apparatus for a garage door as specified in claim 1 wherein said upper attachment means are selected from the group consisting of a hook, a peg, a clip, a stud, a knob, or a protrusion.

4. The plastic bottle storage apparatus for a garage door as specified in claim, 1 wherein said lower attachment means are selected from the group consisting of a hook, a peg, a clip, a screw, or a bolt and nut.

5. The plastic bottle storage apparatus for a garage door as specified in claim 1 wherein said panel or strip having an opening on an upper end that interfaces with said upper attachment means, and an opening on a lower end that interfaces with an upper end of said resilient band.

6. A plastic bottle storage apparatus for a garage door that is an element of an empty plastic bottle recycling system and is used in combination with an empty plastic bottle panel or strip having an opening on an upper end and a lower end and that maintains a plurality of empty plastic bottles prior to recycling, wherein said PBSA allows multiple empty plastic bottle panels or strips with empty plastic bottle secured thereto, to be removably attached to an inner surface of a garage door, wherein said PBSA is comprised of an upper section with a horizontal member, and a lower section with a horizontal member, wherein said horizontal members are attached parallel to each other on an inner surface of a garage door, wherein an empty plastic bottle panel or strip upper end is secured to said upper section horizontal member, and the panel or strip lower end is secured to a resilient band that is attached to said lower section horizontal member, thereby maintaining said panel or strip on the inner surface of the garage door, wherein said resilient band extends and retracts to compensate for the variation in lengths that occur as the garage door opens and closes.

7. The plastic bottle storage apparatus for a garage door as specified in claim 6 wherein said upper section and said lower section are made of a material selected from the group consisting of plastic, metal, wood or a composite.

8. The plastic bottle storage apparatus for a garage door as specified in claim 6 wherein said upper attachment means are selected from the group consisting of a hook, a peg, a clip, a stud, a knob or a protrusion.

9. The plastic bottle storage apparatus for a garage door as specified in claim 6 wherein said lower attachment means are selected from the group consisting of a hook, a peg, a clip, a screw, or a bolt and nut.

10. The plastic bottle storage apparatus for a garage door as specified in claim 6 wherein the garage door is comprised of a sectional garage door.

11. A plastic bottle storage apparatus for a garage door (PBSA) that is used in combination with an empty plastic bottle panel or strip having an opening on an upper end and a lower end, and that maintains a plurality of empty plastic bottles prior to recycling, wherein said PSA allows multiple empty plastic bottle panels, or strips with empty plastic bottles secured thereto, to be removably attached to an inner surface of a sectional garage door, wherein said PBSA is comprised of:
a) an upper section including a horizontal member with a right end and a left end, wherein said horizontal member is secured to an inner surface of a sectional garage door by securing means on the right end, and securing means on the left end,
b) multiple upper attachment means that are longitudinally located along the length of said upper section horizontal member,
c) a lower section including a horizontal member with a right end and a left end, wherein said horizontal member is selected below and parallel to said upper section horizontal member on an inner surface of the sectional garage door by securing means on the right end and the left end, and
d) multiple lower attachment means that are located to directionally correspond to said upper attachment means, wherein said lower attachment means each comprises a resilient band with an upper end having a hook, and a lower end that is secured to said lower section horizontal member by band securing means, wherein the upper end of the panel or strip is secured to said upper attachment means by interfacing the opening on the upper end of the panel or strip with said upper attachment means, and the lower end of the panel or strip is secured to said resilient band by interfacing the opening on the lower end of the panel or strip with the upper end of said band, wherein once the panel or strip with empty bottles thereon is secured, the panel or strip with empty bottles, is maintained on the inner surface of the garage door, wherein said resilient band extends and retracts to compensate for the variation in length that occur when the sectional garage door opens and closes.

12. The plastic bottle storage apparatus for a garage door as specified in claim 11 wherein said upper section horizontal member and said lower section horizontal member are made of a material selected from the group consisting of plastic, metal, wood or a composite.

13. The plastic bottle storage apparatus for a garage door as specified in claim 11 wherein said upper attachment means are selected from the group consist of a hook, a peg, a clip, a stud, a knob or a protrusion.

14. The plastic bottle storage apparatus for a garage door as specified in claim 11 wherein said lower attachment means are selected from the group consist of a hook, a peg, a clip, a screw, or a bolt and nut.

15. The plastic bottle storage apparatus for a garage door as specified in claim 11 wherein said upper section horizontal member is permanently attached by attachment means selected from the group consisting of screws, bolts and nuts, an adhesive, welding, or a hook and loop fastener.

16. The plastic bottle storage apparatus for a garage door as specified in claim 11 wherein said lower section horizontal member is permanently attached by attachment means secured from the group consisting of screws, bolts and nuts, an adhesive or welding.

17. The plastic bottle storage apparatus for a garage door as specified in claim 12 wherein said resilient band is comprised of an elastic cord.

18. The plastic bottle storage apparatus for a garage door as specified in claim 11 wherein said resilient band is selected from the group consisting of a rubber strip, an elastic strip, or a tensioning device.

19. The plastic bottle storage apparatus for a garage door as specified in claim 11 wherein said horizontal members further comprising interlocking ends that allows left or eight horizontal members to be locked together, thereby increasing the structural integrity of a PBSA that is comprised of multiple horizontal members extending across a garage door.

20. The plastic bottle storage apparatus for a garage door as specified in claim 11 further comprising at least two vertical height adjusting hinge plates, each with a bracket that is removable attached to an existing hardware component of a sectional garage door, wherein said hinge plates facilitate the altering of the vertical height of said PBSA, wherein said bracket is removable for transportation, cleaning or counting of the empty bottles on the panels or strips.

21. The plastic bottle storage apparatus for a garage door as specified in claim 11 further comprising said upper section horizontal member and said lower section horizontal member manufactured with telescoping capability which allows the length of each member to be selectively chosen by the insertion or retraction of sections of each said member.

22. The plastic bottle storage apparatus for a garage door as specified in claim 11 further comprising at least one hanging device located on a lower edge of said lower section horizontal member, wherein said hanging device allows various items to be maintained and hung from said horizontal member.

23. The plastic bottle storage apparatus for a garage door as specified in claim 22 wherein said hanging device is selected from the group consisting of a hook, a peg, a clip, a stud, a knob, a protrusion, a chain, a cable, a rope, clamp, hook and loop fastener, a strap, an adhesive, a bolt and nut, a latch, a twist lock, or a rod.

24. A plastic bottle storage apparatus for a garage door (PBSA) that is used in combination with an empty plastic bottle panel or strip having an opening on an upper end and a lower end, and that maintains a plurality of empty plastic bottles prior to recycling, wherein said PSA allows multiple empty plastic bottle panels, or strips with empty plastic bottles secured thereto, to be removably attached to an inner surface of a sectional garage door, wherein said PBSA is comprised of:
a) an upper section including a horizontal member with a right end and a left end, wherein said horizontal member is secured to an inner surface of a sectional garage door by securing means on the right end, and securing means on the left end,
b) multiple upper attachment means that are longitudinally located along the length of said upper section horizontal member,
c) a lower section including a horizontal member with a right end and a left end, wherein said horizontal member is secured below and parallel to said upper section horizontal member on an inner surface of the sectional garage door by securing means on the right end and the left end, and
d) multiple lower attachment means that are located to directionally correspond to said upper attachment means, wherein the upper end of the panel or strip is secured to said upper attachment means by interfacing the opening on the upper end of the panel or strip with said upper attachment means, and the lower end of the panel or strip is secured to said lower attachment means by interfacing the opening on the lower end of the panel or strip with said lower attachment means, wherein once the panel or strip with empty bottles thereon is secured, the panel or strip with empty bottles, is maintained on the inner surface of the garage door.

25. The plastic bottle storage apparatus for a garage door as specified in claim 24 wherein said upper section horizontal member and said lower section horizontal member are made of a material selected from the group consisting of plastic, metal, wood or a composite.

26. The plastic bottle storage apparatus for a garage door as specified in claim 24 wherein said upper attachment means are selected from the group consist of a hook, a peg, a clip, a stud, a knob, a protrusion, a chain, a cable, a rope, clamp, hook and loop fastener, a strap, an adhesive, a bolt and nut, a latch, a twist lock, a rod, or a pin.

27. The plastic bottle storage apparatus for a garage door as specified in claim 24 wherein said lower attachment means are selected from the group consisting of a hook, a peg, a clip, a screw, or a bolt and nut, a stud, a knob, a protrusion, a chain, a cable, a rope, clamp, hook and loop fastener, a strap, an adhesive, a latch, a twist lock, a rod, or a pin.

28. The plastic bottle storage apparatus for a garage door as specified in claim 24 wherein said upper section horizontal member is permanently attached by attachment means selected from the group consisting of screws, bolts and nuts, an adhesive or welding.

29. The plastic bottle storage apparatus for a garage door as specified in claim 24 wherein said lower section horizontal member is permanently attached by attachment means secured from the group consisting of screws, bolts and nuts, an adhesive or welding.

30. The plastic bottle storage apparatus for a garage door as specified in claim 24 wherein said horizontal members further comprising interlocking ends that allows left or eight horizontal members to be locked together, thereby increasing the structural integrity of a PBSA that is comprised of multiple horizontal members extending across a garage door.

31. A plastic bottle storage apparatus for a garage door (PBSA) that is used in combination with an empty plastic bottle strip having an opening on an upper end and a lower end, and that maintains a plurality of empty plastic bottles prior to recycling, wherein said PSA allows multiple empty plastic bottle panels, or strips with empty plastic bottles secured thereto, to be removably attached to an inner surface of a sectional garage door, wherein said PBSA is comprised of:
a) an upper section including a horizontal member with a right end and a left end, wherein said horizontal member is secured to an inner surface of a sectional garage door by securing means on the right end, and securing means on the left end,
b) multiple upper attachment means that are longitudinally located along the length of said upper section horizontal member,
c) a lower section including a horizontal member with a right end and a left end, wherein said horizontal member is secured below and parallel to said upper section horizontal member on an inner surface of the sectional garage door by securing means on the right end and the left end, and
d) multiple lower attachment means that are located to directionally correspond to said upper attachment means, wherein the upper end of the strip is secured to said upper attachment means by interfacing the opening on the upper end of the panel or strip with said upper attachment means, and the lower end of the strip or panel is secured to said lower attachment means by interfacing the opening on the lower end of the strip or panel with said lower attachment means, wherein once the strip or panel with empty bottles thereon is secured, the strip or strip with empty bottles, is maintained on the inner surface of the garage door.

32. The plastic bottle storage apparatus for a garage door as specified in claim 31 wherein said upper section horizontal member and said lower section horizontal member are made of a material selected from the group consisting of plastic, metal, wood or a composite.

33. The plastic bottle storage apparatus for a garage door as specified in claim 31 wherein said upper section horizontal member securing means is comprised of a retractable pin with an outer end and an inner end, and that extends outward from the right end of said horizontal member and the left end of said horizontal member, wherein within said horizontal member, adjacent each end, said pin's inner end interfaces with a spring that allows said pin to be forceably retracted into said horizontal member, or to releasably extend outward from the end of said horizontal member, wherein located on an inner surface of a sectional garage door as existing hardware are multiple hinge brackets, each having openings on an inner side edge, wherein an end of said horizontal member with said pin retracted within is placed in alignment with the opening on a bracket, wherein once in alignment, said pin is releaseably extended outward from said horizontal member into the opening, wherein the pin-into-opening action is performed on both ends of said horizontal member, wherein when pins extend into the openings on both ends, said upper section horizontal member is secured onto the inner surface of the garage door.

34. The plastic bottle storage apparatus for a garage door as specified in claim 31 wherein said lower section horizontal member securing means is comprised of a retractable pin with an outer end and an inner end, and that extends outward from the right end of said horizontal member and the left end of said horizontal member, wherein within said horizontal member, adjacent each end, said retractable pin's inner end interfaces with a spring that allows said pin to be forceably retracted into said horizontal member, or to releasably extend outward from the end of said horizontal member, wherein located on an inner surface of a sectional garage door as existing hardware are multiple hinge brackets, each having openings on an inner side edge, wherein an end of said horizontal member with said pin retracted within is placed in alignment with the opening on a bracket, wherein once in alignment, said pin is releaseably extended outward from said horizontal member into the opening, wherein the pin-into-opening action is performed on both ends of said horizontal member, wherein when pins extend into the openings on both ends, said lower section horizontal member is secured onto the inner surface of the garage door.

35. The plastic bottle storage apparatus for a garage door as specified in claim 31 wherein said upper section horizontal member securing means is comprised of a retractable pin with an outer end and an inner end, and that extends outward from the right end or the left end of said horizontal member, and a stationary pin that extends outward from the horizontal member at the opposing end where said retractable pin is located, wherein said stationary pin is placed in alignment with and inserted into an opening on an existing hardware hinge bracket located on the inner surface of the garage door, wherein said retractable pin's inner end interfaces with a spring that allows said pin to be forceably retracted into said horizontal member, or to releaseably extend outward from the end of said member, wherein said retractable pin is retracted and placed in alignment with an opening on a bracket that is horizontally aligned with and at a distance from the bracket said stationary pin is inserted into, wherein said retractable pin is releaesably extended outward from said horizontal member into the opening, wherein with said stationary pin on one said horizontal member end inserted into a bracket opening, and said retractable pin on the opposing end of said horizontal member inserted into another bracket, said upper section horizontal member is secured onto the inner surface of the garage door.

36. The plastic bottle storage apparatus for a garage door as specified in claim 31 wherein said lower section horizontal member securing means is comprised of a retractable pin with an outer end and an inner end, and that extends outward from the right end or the left end of said horizontal member, and a stationary pin that extends outward from the horizontal member at the opposing end where said retractable pin is located, wherein said stationary pin is placed in alignment with and inserted into an opening on an existing hardware hinge bracket located on the inner surface of the garage door, wherein said retractable pin's inner end interfaces with a spring that allows said pin to be forceably retracted into said horizontal member, or to releaseably extend outward from the end of said member, wherein said retractable pin is retracted and placed in alignment with an opening on a bracket that is horizontally aligned with and at a distance from the bracket said stationary pin is inserted into, wherein said retractable pin is releaesably extended outward from said horizontal member into the opening, wherein with said stationary pin on one said horizontal member end inserted into a bracket opening, and said retractable pin on the opposing end of said horizontal member inserted into another bracket, said lower section horizontal member is secured onto the inner surface of the garage door.

37. The plastic bottle storage apparatus for a garage door as specified in claim 31 wherein said upper section horizontal member having at least one opening into which is inserted a vertical locking rod that maintains the horizontal directional integrity and anti-rotation of said member, and prevents a twisting movement of said member.

38. The plastic bottle storage apparatus for a garage door as specified in claim 31 wherein said lower section horizontal member having an opening into which is inserted a vertical locking rod that maintains the horizontal directional integrity and anti-rotation of said member, and prevents a twisting movement of said member.

39. The plastic bottle storage apparatus for a garage door as specified in claim 31 wherein said upper attachment means are selected from the group consist of a hook, a peg, a clip, a stud, a knob, a protrusion, a chain, a cable, a rope, clamp, hook and loop fastener, a strap, an adhesive, a bolt and nut, a latch, a resilient band, a twist lock, a rod, or a pin.

40. The plastic bottle storage apparatus for a garage door as specified in claim 31 wherein said lower attachment means are selected from the group consisting of a hook, a peg, a clip, a screw, or a bolt and nut, a stud, a knob, a protrusion, a chain, a cable, a rope, clamp, hook and loop fastener, a strap, an adhesive, a latch, a resilient band, a twist lock, a rod, or a pin.

41. The plastic bottle storage apparatus for a garage door as specified in claim 31 wherein said horizontal members further comprising interlocking ends that allows left or right horizontal members to be locked together, thereby increasing the structural integrity of a PBSA that is comprised of multiple horizontal members extcnding across a garage door.

42. The plastic bottle storage apparatus for a garage door as specified in claim 31 further comprising at least one hanging device located on a lower edge of said lower section horizontal member, wherein said hanging device allows various items to be maintained and hung from said horizontal member.

43. The plastic bottle storage apparatus for a garage door as specified in claim 40 wherein said hanging device is selected from the group consisting of a hook, a peg, a clip, a stud, a knob, a protrusion, a chain, a cable, a rope, clamp, hook and loop fastener, a strap, an adhesive, a bolt and nut, a latch, a resilient band. a twist lock, or a rod.
